(19) United States
(12) Patent Application Publication
(10) Pub. No.: US 2009/0037729 A1
(43) Pub. Date: Feb. 5, 2009

(54) AUTHENTICATION FACTORS WITH PUBLIC-KEY INFRASTRUCTURE

(76) Inventors: Lawrence Smith, Concord, CA (US); Ian MacDonald, Benicia, CA (US); Alex Zeltser, Oakland, CA (US)

Correspondence Address: SCHWEGMAN, LUNDBERG & WOESSNER, P.A., P.O. BOX 2938, MINNEAPOLIS, MN, 55402, US

(21) Appl. No.: 11/833,823

(22) Filed: Aug. 3, 2007

(51) Int. Cl. H04L 9/32; H04L 9/00; H04L 9/30

(52) U.S. Cl. 713/158; 380/44; 713/171; 726/9

(57) ABSTRACT

A user access control system comprising a workstation coupled to a computer network and operable to receive a request for an authenticated access to the computer network, and to prompt for and receive one or more credentials associated with the request, a gating authentication server coupled to the computer network and operable to receive the one or more credentials and to provide as a gating factor an authenticated credential, and a public key infrastructure server coupled to the computer network and operable to generate private/public key pairs associated with the authenticated credential, wherein the private/public key pairs are either generated after a request for access to the computer system has been received at the workstation and the gating authentication server has authenticated the one or more credentials provided through the workstation, or the private/public key pairs are retrieved from a previously generated virtual smart card based on the authentication credential.

### BACKGROUND OF THE INVENTION

1. Field of the Invention

The present invention is related to computer network security, and more particularly, authentication factors for accessing resources in a computer network.

2. Background Information

As the world moves toward a proliferation of internets, intranets, and extranets, user authentication has become increasingly important. In general, there are three universally recognized factors used for authenticating users to a computer network. A first factor is based on something you know, such as a password, a personal identification number (PIN), or an out of wallet response. Passwords, PINs, and out of wallet responses are examples of information supposedly only known to the user and to an authentication or security portion of the computer network. A second factor is based on something you have, such as a credit card, a hardware security token, or a smart card. A third factor is based on something you are, such as a fingerprint, a retinal scan, or other biometrics that are intended to uniquely identify a potential user of the computer network.

Requiring a user to provide one of these factors in order to gain access to a computer network provides a level of security, wherein parties attempting to access the computer network and who are not able to provide the requested authentication factor are denied access to the computer network. However, these factors have limitations in their ability to protect a computer network. For example, a common example of user authentication is a static, user selected password. These static, user selected passwords are inherently limited as protection devices because they are subject to password guessing and other hacking methods. One time passwords, or dynamic passwords, overcome many of the limitations of static, user selected passwords.

Another way to provide stronger authentication for computer networks is known as two-factor authentication. In two-factor authentication, two different methods are used in order to authenticate a user. Using two-factor authentication provides a higher level of security for a computer network.

### BRIEF DESCRIPTION OF THE DRAWINGS

FIG. 1 shows a computer network according to various embodiments;

FIG. 2 shows a functional block diagram of a virtual smart card based login procedure according to various embodiments;

FIG. 3 shows a functional block diagram a Windows® based implementation of a virtual smart card based login procedure according to various embodiments; and

FIG. 4 shows a method 400 according to various embodiments of the present subject matter.

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

Smart cards provide one form of authentication for users in a computer network. For instance, smart cards can be used to carry a user's identity securely and conveniently. In a typical smart card authentication system, users approach a terminal and inserts their smart card into a smart card reader. The system queries the smart card through the smart card reader and performs a user authentication based on a series of cryptographic operations that can only be completed using the private key stored on the smart card. In systems that utilize a smart card, a smart card reader is required to be attached and configured at each workstation where smart card authentication is going to occur. This requires that individual smart card readers be installed at a multitude of workstations, and that each smart card reader be configured and maintained at each of these workstations. Security issues must also be addressed for each of the smart card readers.

One technique for avoiding the need to upgrade each workstation to enable using smart card authentication is to have an implementation including virtual smart cards. In various embodiments, virtual smart cards are stored on a virtual smart card storage device, such as a virtual smart card server. Each virtual smart card stored on the virtual smart card storage device is associated with a user, and is operable to provide at least one factor in authentication of the particular user associated with each of the virtual smart cards. By employing virtual smart cards in a computer network, the need to have smart card readers at each of the workstations is eliminated. Further, since the virtual smart cards can be maintained at a server location, control and security of the virtual smart cards is easier with respect to configuration, control, security, and maintenance issues related to the virtual smart cards, as these functions can be implemented and controlled at the virtual smart card server, as opposed to having to perform these functions at a plurality of individual workstations where smart card readers would be employed.

In various embodiments, the virtual smart cards are used in conjunction with a public key authentication system, wherein each virtual smart card includes a private key. Each private key is part of a public/private key pair associated with a public key infrastructure (PKI) based authentication system. In public key cryptography utilizing a PKI based authentication system, a user has a pair of cryptographic keys, including a public key that is published or otherwise widely distributed, and a private key that is kept secret. The keys are related mathematically, but the private key cannot be practically derived from the public key. A message encrypted with the public key can be decrypted only with the corresponding private key. In various embodiments, the private key is kept as part of the information included on a virtual smart card associated with a user who is authorized for access to a computer network based on the virtual smart card.

The public key infrastructure (PKI) is an arrangement that binds the public key with the respective users' identities through a certificate authority (CA). Public key infrastructures allow computer user without prior contact to be authenticated to each other, and to use the public key information in their public keys to encrypt messages to each other. Public key infrastructure specifications do not directly address authentication and access control. Authorization and access control are, however, necessary components in any public key authentication scheme.

Embodiments include apparatus, methods, and systems as described herein include using one authentication factor or multi-factor authentication to initiate generation of “just in time” temporal key pairs and temporal certificates that provide authenticated access to a computer network. Various embodiments described herein including using one authentication factor or multi-factor authentication to control access to virtual smart cards, and in combination with the virtual smart cards, providing two authentication factors (two-factor authentication) for strong authentication on a computer network, while also handling the issuance and enrollment of public key infrastructure certificates in the background. Embodiments are beneficial in that they are scalable and can leverage existing operating systems for PKI technologies, while providing strong authentication for computer networks.

In addition, embodiments as described herein do not require an immediate investment in additional hardware or infrastructure for implementation. By way of illustration, the embodiments described herein do not require an investment in physical smart card readers coupled to any of the workstations of a computer network. Various embodiments as described herein provide an authentication factor operable on systems designed for use with using smart cards, but eliminating the need for the physical devices that would be required to read physical smart cards, and while still providing a gating factor for accessing temporal certificates and temporal private keys associated with public/private key pairs, all within an authentication structure that incorporates the benefits of a PKI-based authentication system.

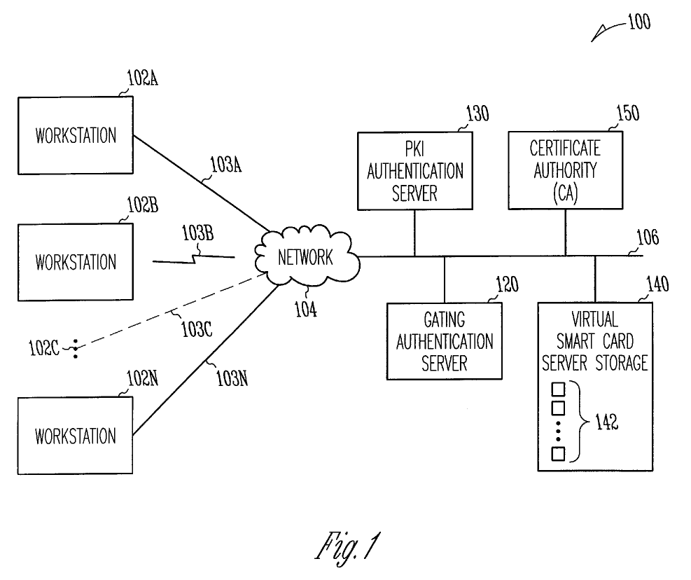

FIG. 1 illustrates a computer network 100 according to various embodiments. Computer network 100 includes a plurality of workstations 102A-N, a gating authentication server 120, a Public Key Infrastructure (PKI) authentication server 130, and a certificate authority 150. In various embodiments, computer network 100 includes a virtual smart card server storage 140.

In various embodiments, workstations 102A-N are coupled through network 104 to interconnect 106. Network 104 is not limited to any particular type of network, and may include any type of network or networks operable to couple any number of workstations 102A-N to interconnect 106. In various embodiments, network 104 includes wired or wireless networks. Network 104 may include any combination of Personal area networks (PAN), Local area networks (LAN), Campus area networks (CAN), Metropolitan area networks (MAN), and Wide area network (WAN). Network 104 is not limited to a single network, and may include a plurality of networks including one or more different networks operating using one or more protocols, as would be understood by one of skill in the art of networks. The network communication may be any combination of wired and wireless communication. In some embodiments, the network communication may be based on one or more communication protocols (e.g., HyperText Transfer Protocol (HTTP), HTTP Secured (HTTPS), etc.).

Workstations 102A-N are not limited to a particular number of workstations, and may include any number workstation as represented by dotted line 102C. Workstations 102A-N are not limited to any particular type of workstations, and are not limited to having workstations 102A-N comprised of a same type of workstations for all of workstations 102A-N. Workstations 102A-N may be any combination of types of workstations, including personal computers, laptop computers, computer terminals, personal digital assistants, or cell phones. Workstations 102A-N are coupled to network 104 through interconnects 103A-N respectively. Interconnects 103A-N are not limited to any particular type of interconnects. In various embodiments, one or more of workstations 102A-N is coupled to network 104 using a wireless interconnect, as represented by interconnect 103B.

In various embodiments, gating authentication server 120, PKI authentication server 130, and certificate authority 150 are coupled to interconnect 106. Interconnect 106 is not limited to any particular type of interconnect, or to a single interconnect, and includes any type of interconnect or interconnects operable to allow communications and data transfers between the workstations 102A-N coupled to network 104, gating authentication server 120, PKI authentication server 130, and certificate authority 150.

In various embodiments, virtual smart card server storage 140 is coupled to interconnect 106. In various embodiments, virtual smart card server storage 140 is operable to store one or more virtual smart cards 142. In various embodiments, each of the virtual smart cards 142 provides an authentication factor for a particular user authorized to access computer network 100 through one of workstations 102A-N. In various embodiments, at least one of the virtual smart cards 142 includes a private key portion of a PKI key pair associated with a particular user authorized to access computer network 100 through one of workstations 102A-N.

In operation, a user requests access through one of workstations 102A-N to one or more resources coupled to computer network 100. In various embodiments, resources include login access to computer network 100. In various embodiments, resources include access to communicate with another workstation on computer network 100.

The request for access by the user includes an indication made by the user at one of workstations 102A-N for an access to computer network 100. In response, the workstation prompts the user for a set of credentials necessary to gain access to the computer network 100. The credentials are not limited to any particular credentials, and include any credentials operable to identify a user to the computer network 100. In various embodiments, the set of credentials includes, but is not limited to, one or more of the following: fixed passwords, dynamic passwords, PINs, and biometrics.

Upon receiving the credentials, the workstation communicates to gating authentication server 120 a request to authenticate the requested access based on the provided credentials. Verifying the credentials at the gating authentication server 120 is not limited to any particular type of verification process, and includes any type of verification process that is operable to verify a user based on the provided credentials. By way of illustration, for credentials that consist of a user ID and memorized PIN, the credentials are gathered from the user and securely transmitted to the gating authentication server 120. The gating authentication server 120 will look up the user ID in a database and then compare the expected PIN to the one supplied. If they match then the user is considered to have passed authentication.

By way of further illustration, for credentials including one-time passwords, the user again supplies his user ID when prompted but then using a hardware or software password token that is in their possession, generates a one-time (single use) password and enters that when prompted. The one-time password is generated based on a secret key that is securely stored in both the token and the gating authentication server database. When the gating authentication server 120 receives the user ID and one-time password, it looks up the user ID in a database along with the user's secret key. The gating authentication server then generates the expected one-time password and compares it to the supplied one-time password. If the passwords match the user is considered to have passed authentication. There are several modes of operation available with tokens and one-time passwords that may include additional PINs and challenge/response sequences, and embodiments are not limited to any particular mode of operation that include tokens and one-time passwords.

If the gating authentication server 120 authenticates the credentials, the authenticated credentials provide a gating factor that can be used by the workstation to control access to a temporal certificate required to complete the requested logon. In various embodiments, the authenticated credentials are provided to the PKI authentication server 130 with a request to generate a temporal certificate and a temporal key pair to complete the requested logon. In various embodiments, the PKI authentication server 130 will generate the temporal key pair based on the authenticated credentials. In various embodiments, certificate authority 150 will generate a temporal certificate based on the authenticated credentials. The certificate and the key pair are referred to as “temporal” because they are generated to have a life span that is much shorter than a typical certificate generated by a certificate authority, as further explained herein.

The basic operation of PKI authentication in various embodiments involves a set of cryptographic keys; one private, securely stored and know only to the user and the other, derived from the private key and made public. The keys are then used to generate a certificate request. The public key along with other attributes are embedded in the certificate request and then digitally signed by the user's private key. This certificate request is then transmitted to a certificate authority (CA) 150.

In various embodiments, other entities such as an operating system or application included for example in a workstation, are configured to trust the CA. This means that it will trust any certificate that has been signed by the CA's private key. It can do this by obtaining the CA's public key and verifying the signature of any certificate that was issued by the CA 150.

Upon receiving a temporal certificate and a temporal key pair, the workstation is able to complete a logon and to gain assess to computer network 100 for the user providing the credentials through the workstation. In some embodiments, the logon completed is a smart card logon wherein the logon process is configured for a logon using a smart card, but wherein the temporal certificate and the temporal key are used to complete the smart card login as if a smart card had been used but without the need for a smart card, either physical or virtual, to be provided.

In various embodiments, once the credentials have been authenticated by gating authentication server 120, and in embodiments including a virtual smart card server storage 140, the authenticated credentials provide a gating factor allowing access to at least one of the virtual smart cards 142 associated with the authenticated credentials. In various embodiments, the virtual smart card 142 accessed includes an already generated temporal key pair associated with the authentication credentials. In various embodiments, the accessed virtual smart card includes a temporal certificate associated with the already generated temporal key pair.

In embodiments employing the authenticated credentials as a gating factor for accessing the stored virtual smart cards 142, the accessed virtual smart card 142 is used to provide temporal keys to the workstation in order to compete the logon and allow access to computer network 100. In various embodiments, the accessed virtual smart card 142 also provides the temporal certificate used to complete the logon. In various embodiments, the authenticated credentials are used as a gating factor to control access to the certificate authority 150, wherein the certificate authority 150 provides the temporal certificate based on the authenticated credentials.

Thus, the private key in a private/public key pair is securely stored in either local storage or on in the virtual smartcard server storage. Access to the private key is governed by the gating authentication server 120. The private key is used at login to digitally sign or encrypt some piece of data that can then be validated by the OS or application by use of the user's public key (which is contained in the user's certificate). If this validation succeeds and the certificate (containing the user's public key) has been signed by a trusted CA, then the user is also considered trusted and passes authentication.

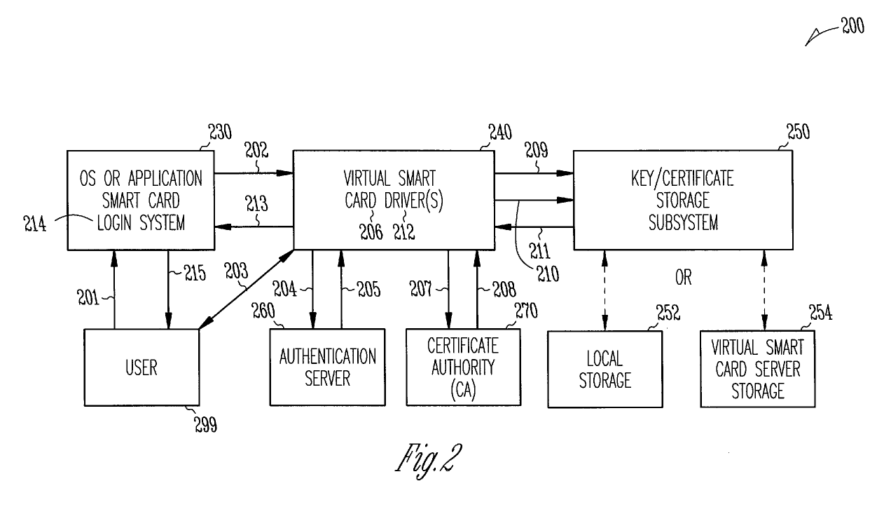

FIG. 2 shows a functional block diagram 200 of a virtual smart card based login procedure. Various embodiments include using authenticated credentials as a gating factor for generating “just in time” temporal certificates and temporal PKI compatible key pairs. Various embodiments include using authenticated credentials as a gating factor for controlling access to stored virtual smart cards. Various embodiments include using authentication tokens as the gating factor.

Diagram 200 includes a smart card login system module 230, a smart card drivers module 240, and a key/certificate storage subsystem 250, an authentication server 260, and a certificate authority (CA) 270. Various embodiments include local storage 252 coupled to key/certificate storage subsystem 250. In various embodiments, local storage 252 is physically located in one of the workstations where users request and gain access to a computer network. Various embodiments include virtual smart card server storage 254 coupled to key/certificate storage subsystem 250. It would be understood that modules 230 and 240, and that any one and each of authentication server 260, certificate authority 270, and key/certificate storage subsystem 250 are not limit to being comprised of strictly software or strictly hardware, and are not limited to any particular software or any particular hardware, and each may include any combination of software, hardware, or both software and hardware, that is operable to perform the functions as described herein.

In various embodiments, one or more of modules 230 and 240 may be included in a workstation, such as but not limited to any of workstations 102A-N as shown in FIG. 1.

Referring again to FIG. 2, authentication server 260 is not limited to any particular type of server. In various embodiments, authentication server 260 includes a SafeWord® PremierAccess® (SPA) authentication system. SafeWord® PremierAccess® authentication system is a software product of Secure Computing® Corporation of Concord, Calif.

For various embodiments as depicted in diagram 200, one or more possible sequences of operations 201-215 are described. However, it would be understood that embodiments are not limited to the sequences of operations as depicted in diagram 200, and different sequences, including more or fewer operations, are possible and are contemplated by various embodiments of the present subject matter.

Note that in this sequence of operations as shown in diagram 200, there is no requirement that certificates used for authentication be pre-generated and deployed prior to authentication of a user's credentials. Rather than leveraging pre-existing certificates (typically valid for multi-month or multi-year periods) the system of diagram 200 dynamically generates short-lived, ‘temporal’ certificates, with much shorter life spans. In various embodiments, the life span of the temporal certificates is less than a day. In various embodiments, the life span of the temporal certificate is 4 hours or less. In various embodiments, once a temporal certificate expires, further requests for access by a user associated with the expired temporal certificate will not be granted unless a subsequent temporal certificate is generated. The generation of the subsequent temporal certificate in various embodiments will require the user to again provide credentials when prompted to do so, and the authentication of the credentials as a gating factor in allowing or denying access to a newly generated or a stored temporal certificate.

In various embodiments, a temporal certificate can be configured to expire at the termination of a session for which the temporal certificate was generated. By way of illustration, logon request for an authenticated access by result in a temporal certificate being generated in order to enable the authenticated access, but wherein the temporal certificate not only expires at some relatively short time frame, but is revoked or expires when the session resulting from the authenticated access is terminated, even if the time limit for the temporal certificate has not been exceeded during the session.

As shown in diagram 200, at operation 201, a user 299 requests authenticated access. The request may be made through any workstation, such as but not limited to any of workstations 102A-N as shown in FIG. 1.

Referring again to FIG. 2, at operation 202 an authenticating platform included in smart card login system 230 contacts the virtual smart card drivers 240 to perform a series of cryptographic operations that can only be completed using the private key associated with the user's certificate.

At operation 203, virtual smart card drivers 240 prompt the user 299 for credentials. As noted above, credentials are not limited to any particular type of credential, and in various embodiments include any credentials, such as a PIN, a one-time password, or a biometric, or any other credential usable to gate the requested access to the necessary key or keys and certificate or certificates associated with the user 299 who is requesting the access. In various embodiments, the necessary key or keys are any keys associated with a PKI-based authentication system. Operation 203 includes receiving back from user 299, either directly or through login system 230 the credentials prompted for by the virtual smart card drivers 240.

At operations 204, the smart card drivers 240 makes a request to the authentication server 260 to authenticate the credentials provided by user 299. At operation 205, authentication server 260 returns to the virtual smart card drivers 240 the results of the request to authenticate the credentials. The returned results may include a validation of the credentials, or a failed authentication based on the credentials. If the authentication request results in a failed authentication, the user 299 is denied the access being requested. In various embodiments, the user 299 may again request access by staring over at operation 201. In various embodiments, the smart card drivers 240 may inform the user 299 of the failed authentication. In various embodiments, in the event of a failed authentication, virtual smart card drivers 240 or the smart card login system 230 may prompt the user 299 to retry the entering of the credentials, and if retried, the newly entered credentials are resent to authentication server 260 along with a second authentication request.

In various embodiments, if the authentication of the credentials is successful, authentication server 260 provides an authentication token that may be used as a gating factor for having a temporal certificate and temporal keys associated with the authenticated credentials generated, or for gaining access to previously generated temporal certificates and keys that are associated with the authenticated credentials. In various embodiments, the authentication token is needed in order to have a temporal certificate associated with the authenticated credentials generated.

Operations 201-205 may be referred to at occurring at an authentication time of the operations depicted by operations 201-215.

Upon successful authentication, depending on system settings, the system may either generate a new ‘just in time’ temporal certificate (Scenario A), or fetch an existing one (Scenario B). In some embodiments, very short-lived temporal certificates are generated for every authentication request. However, since key pair and certificate generation are computationally-expensive operations, further exacerbated by additional network overhead, some embodiments include caching of previously generated keys and certificates. Scenario B describes the alternative steps that would be present in such embodiments under Scenario B.

Describing now one possible scenario referred to above as Scenario A, at operation 206 a private/public key pair (the “temporal” key pair) is generated by the virtual smart card drivers 240. The generated private/public key pair is referred to as a “just in time” key pair as the key pair is not pre-generated, and is only generated after a request for access has been received and authenticated by the authentication server 260.

At operation 207, smart card drivers 240 makes a Certificate Signing Request (CSR) to the certificate authority (CA) 270 in order to have certificate authority 270 issue a certificate based on given temporal key pair. At operation 208, certificate authority 270 issues a new certificate, referred to as the temporal certificate, and returns the new certificate to virtual smart card drivers 240. Both the temporal key pair and the temporal certificate are generated after and in response to the request for access, the prompting for credentials, and the authentication of any credentials provided in response to the prompting. The feature eliminates the need for pre-generated and stored PKI key pairs and certificates while still providing authenticated access within an application platform requiring authenticated access.

In various embodiments, and depending on the implementation and the configuration being used, at operation 209 virtual smart card drivers 240 communicate with key/certificate storage system 250 to store the newly-generated temporal keys and temporal certificate. In various embodiments, local storage 252 is used to store the newly-generated temporal certificate and private/public key pair. In various embodiments, a virtual smart card server storage 254 is used to store the newly generated temporal certificate and the private/public key pair. In various embodiments, virtual smart card server storage 254 is operable to store a plurality of temporal certificates and private/public key pairs associated with the temporal certificates generated in response to different requests for access, including different requests for access originated by different users.

Describing now another possible scenario referred to above as Scenario B, upon successful authentication at operation 205, Scenario B proceed at operation 210 by having the virtual smart card drivers 240 communicating with key/certificate storage subsystem 250 to request from and obtain a previously stored temporal certificate and temporal keys associated with the authenticated credentials. In various embodiments of Scenario B, the requested temporal certificate and the temporal keys are stored at local storage 252. In various embodiments of Scenario B, the temporal certificate and temporal keys are stored at virtual smart card server storage 254, depending on the configuration and the implementation being used.

At operation 211, the key/certificate storage subsystem 250 responds by returning the requested temporal certificate and key pair to virtual smart card drivers 240.

Regardless of the implementation and configuration choice, following either operation 208 in Scenario A or operation 211 in Scenario B, the virtual smart card drivers 240 have the temporal certificate and temporal key pair associated with the authenticated credentials generated from operation 205.

At operation 212, smart card drivers 240 perform necessary cryptographic operations, thus proving the validity of collected key(s). At operation 213, the user's certificate is returned to the authenticating platform of the smart card login system 230.

At operation 214, the authentication platform of the smart card logon system 230 does further validation of the temporal certificate. In various embodiments, the further validation includes checking a Certificate Revocation List (CRL) to determine if the certificate has been revoked. A CRL is a list of certificates (more accurately, their serial numbers) that have been revoked, are no longer valid, and should not be relied on. In various embodiments, the further validation includes using Online Certificate Status Protocol as a mechanism for verifying the status of a certificate.

At operation 215, the user 299 is granted or denied access based on the status of the outcome of operations 201-214.

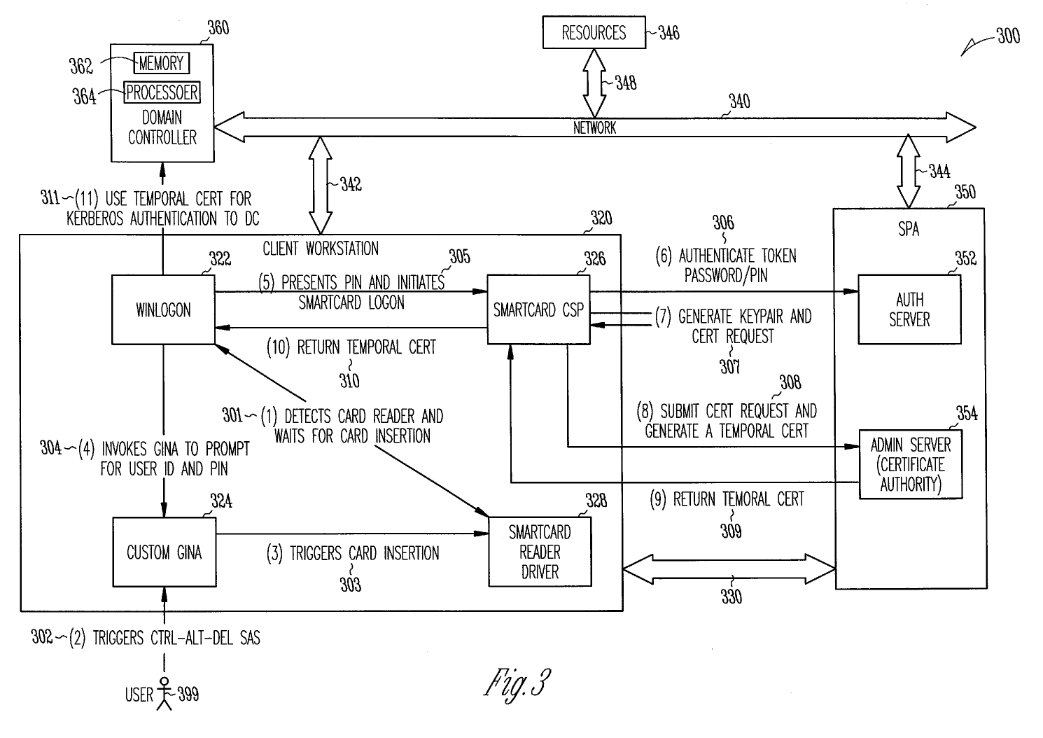

FIG. 3 shows a functional block diagram 300 of embodiments of a Windows® operating system based implementation of a virtual smartcard based login procedure. Windows® operating system is a name associated with several families of proprietary software operating systems by Microsoft® Corporation of Redmond, Wash., USA.

Diagram 300 includes a client workstation 320 and a SafeWord® PremierAccess® (SPA) module 350 coupled to a network 340. In various embodiments, client workstation 320 and SPA 350 are coupled through interconnect 330. In various embodiments, client workstation 320 includes a Winlogon module 322. Winlogon, is a component included in one or more Microsoft Windows® operating systems. As shown in diagram 300, client workstation 320 includes a custom graphical identification and authentication (GINA) DLL 324, a virtual smart card cryptographyic service provider (CSP) 326, and a virtual smart card reader driver 328. In various embodiments, the SPA 350 includes an authentication server 352, and administration server with certificate authority (CA) 354.

In various embodiments, client workstation 320 is coupled to network 340 through domain controller 360. In various embodiments, domain controller 360 includes one or more processors 364 coupled to memory 362. In various embodiments, client workstation 320 is coupled to network 340 through interconnect 342. In various embodiments, SPA 350 is coupled to network 340 through interconnect 344. In various embodiments, resources 346 are coupled to network 340 through interconnect 348. Resources 346 are not limited to any particular type or to any particular number of resources, and may include any type of resources coupled to network 340. In various embodiments, resources 346 includes addition client workstations. In various embodiments, resources 346 includes resources that may be requested for some type of access by a user through client workstation 320.

Network 340 is not limited to any particular type of network, or to a particular number of networks, and may include any network types and numbers of networks coupled to provide a network operable to couple resources 346, domain controller 360, client workstation 320, and SPA 350. Interconnects 330, 342, 344, and 348 are not limited to any particular types of interconnects, or to any particular number of interconnects, and may include any types and numbers of interconnects, including different interconnects, operable to provide the couplings depicted in diagram 300.

In various embodiments, the Winlogon process 322 is operable to control the interaction between the user 399 and other logon components. In various embodiments, the custom GINA DLL 324 is operable to prompt for and to collect the necessary credentials that are to be passed to the authentication server 352. In various embodiments, custom GINA DLL 324 is operable to provide to smart card reader driver 328 an indication that a smart card is present at a smart card reader, even when a smart card reader is not present or even coupled to client workstation 320. In response to an indiction that the a smart card is present, smart card reader driver 328 is operable to provide to Winlogon 322 a trigger signal to initiate the PKI-based smartcard authentication sequence. In various embodiments, the smart card CSP 326 is operable to implement the necessary cryptographic operations used in PKI-based authentication architectures. In various embodiments, it is also responsible for forwarding the collected credentials to the authentication server 352 and, upon successful authentication, retrieving the necessary cryptographic keys. In various embodiments, smart card reader driver 328 is the component operable to simulate the presence of a physical smart card reader on the system. For example, it is responsible for generating smart card insertion or removal events that are then processed by the Winlogon process 322.

In various embodiments, authentication server 352 receives the credentials collected by the custom GINA DLL 324, and passed to it by the smart card CSP 326. The authentication server 352 is operable to grant or deny access based on the validity of those credentials. For example, the credentials may include SafeWord® one-time passwords, fixed passwords, or biometrics. SafeWord® one-time passwords are a software product of Secure Computing® Corporation of Concord, Calif. In various embodiments, the administration server 354 provides CA services to the system, processing Certificate Signing Requests (CSR) from the Smart Card CSP 326 and generating ‘just in time’ temporal certificates used for authentication by the underlying platform.

For various embodiments, a possible sequence of operations 301-311 is described with respect to FIG. 3. However, it would be understood that embodiments are not limited to the sequence of operations as depicted in FIG. 3, and different sequences, including more or fewer operations, are possible and are contemplated by various embodiments of the present subject matter.

As shown in diagram 300, at operation 301 the Winlogon 322 is operable to detect the presence of smart card reader driver 328, and wait for a card insertion. However, client workstation 320 is not necessarily equipped with a physical device for reading smart cards, and will incorporate a “virtual” smart card operation as further described herein. In various embodiments, operations as described with respect to diagram 300 do not require the use of a smart card at all, including not requiring either a physical smart card or a stored virtual smart card to be used in accessing network 340.

As shown in diagram 300, at operation 302 Winlogon 322 is operable to detect the presence of the virtual smartcard reader/driver 328, and wait for a card insertion. However, client workstation 320 is not necessarily equipped with a physical device for reading smart cards, and will incorporate a “virtual” smart card operation as further described herein. At operation 302 (for example, using a ‘Secure Attention Sequence’ of ‘Alt-Ctrl-Del’ under Windows® operating systems), a user 399 triggers a request for access to computer network 340. In various embodiments, a request for access includes a request to log on to computer network 340. In various embodiments, the request for access includes a request for access to one or more of resources 346 coupled to network 340. In various embodiments, operation 302 is received by custom GINA 324. At operation 303, in response to the request, custom GINA 324 prompts virtual smart card reader driver 328 to generate a card insertion event.

At operation 304, Winlogon 322 invokes custom GINA 324 to prompt user 399 for one or more credentials. When provided, the credentials may include, but are not limited to, a user ID and PIN. In various embodiments, custom GINA DLL 324 prompts the user for credential to be provided. Once provided, at operation 305 the obtained credentials are provided to virtual smart card CSP 326 to initiate a smart card logon.

At operation 306, virtual smart card CSP 326 provides a request to authentication server 352. If the provided credentials are authenticated at authentication server 352, an indication of authentication is received at virtual smart card CSP 326. At operation 307, virtual smart card CSP 326 generates a key pair and a certificate request. At operation 308, virtual smart card CSP 326 submits the certificate request to administration server with certificate authority 354. At operation 309, administration server with certificate authority 354 returns a temporal certificate to the virtual smart card CSP 326.

At operation 310, virtual smart card CSP 326 returns the temporal certificate to Winlogon 322. At operation 311, Winlogon 322 accepts the temporal certificate as the smart card insertion, and proceeds providing access based on the user provided request. In various embodiments, access is controlled and granted through domain controller 360.

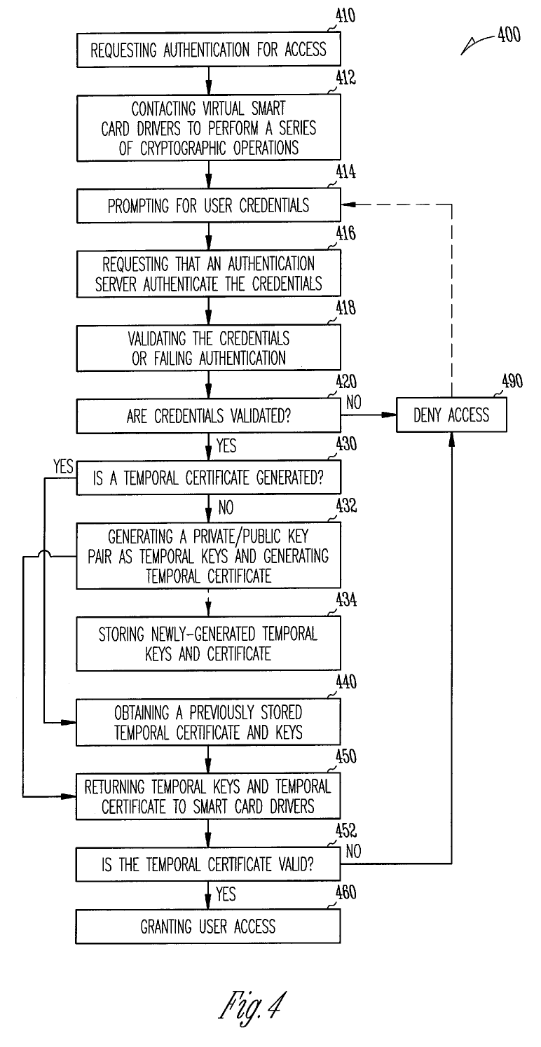

FIG. 4 shows a method 400 according to various embroilments of the present subject matter.

At block 410, method 400 includes requesting authentication for access to a computer network. At block 412, method 400 includes contacting a virtual smart card driver to perform a series of cryptographic operations. At block 414, method 400 includes prompting for user credentials. In various embodiments, the user credentials are credentials to be provided by the entity requesting authentication for access to the computer network at block 410.

At block 416, method 400 includes requesting that an authentication server authenticate the credentials provided in response to the prompt at block 414. In various embodiments, the credentials include a user ID and a PIN. In various embodiments, the credentials include a one-time password. In various embodiments, the credentials include a biometric.

At block 418, method 400 includes validating the credentials or failing authentication. In various embodiments, failing authentication includes notifying the user prompted for the credentials that the authentication failed. In various embodiments, failing authorization of the credentials includes prompting the user to re-enter the credentials.

At block 420, method 400 includes determining if the credentials are validated. In various embodiments, if the credentials are not validated, method 400 proceeds to block 490 including denying access. If the credentials are validated, method 400 proceeds to block 430.

At block 430, method 400 includes determining if a temporal certificate is generated based on the authenticated credentials. If a temporal certificate has not been generated based on the authenticated credentials, method 400 proceeds to block 432. At block 432, method 400 includes generating a private/public key pair as temporal keys and generating a temporal certificate, all based on the authenticated credentials.

In various embodiments including block 432, method 400 includes at block 434 storing the newly-generated temporal keys and temporal certificate. In various embodiments including block 432, following the generation of the temporal keys and temporal certification, method 400 proceeds to block 450.

In various embodiments, if a temporal certificate has been generated based on the authenticated credentials at block 430, method 400 proceeds to block 440, including obtaining a previously stored temporal keys and temporal certificate. In various embodiments including block 440, method 400 proceeds from block 440 to block 450.

At block 450, method 400 includes returning the temporal keys and temporal certificate to smart card drivers.

At block 452, method 400 includes the smart card drivers determining if temporal certificate is valid. If the temporal certificate is valid, method 400 proceeds to block 460, including granting the user access to the computer network. If the certificate is not valid, method 400 proceeds to block 490, including denying access.

In various embodiments, the one or more embodiments of the methods described herein are stored as a set of instructions on a computer readable media, including but not limited to a computer memory. Examples of articles comprising computer readable media are floppy disks, hard drives, CD-ROM or DVD media, or any other read-write or read-only memory device, including flash memory devices. Computer memory used for storing the set of instructions in not limited to being in any particular physical location. In various embodiments, computer memory may be included in any one or more of workstations 102A-N, gating authentication server 120, PKI authentication server 130, CA 150, and virtual smart card server storage 140 as shown in FIG. 1, and any one or more of the blocks 230, 240, 250, 252, 254, 260, and 270 as shown in FIG. 2, and any one or more of blocks 320, 350, and 360 and any of resources 346 as shown in FIG. 3.

Embodiments described herein include a user access control system for use in a computer systems having user authenticated accesses, the system comprising a workstation coupled to a computer network, the workstation operable to receive a request for an authenticated access to the computer network, and to prompt for and receive one or more credentials associated with the request, a gating authentication server coupled to the computer network and operable to receive the one or more credentials provided through the workstation and to provide as a gating factor an authenticated credential as a gating factor in response to receiving and validating the one or more credentials, and a public key infrastructure server coupled to the computer network and operable to generate private/public key pairs associated with the authenticated credential, wherein the private/public key pairs are generated after a request for access to the computer system has been received at the workstation and the gating authentication server has authenticated the one or more credentials provided through the workstation.

Embodiments described herein include a method of authenticating users requesting access on a computer network, the method comprising receiving a request for authenticated access to a computer network, prompting for at least one user credential, receiving at least one credential in response to the prompt, validating the received at least one credential by providing an authenticated credentials if the received at least one credential is valid, requesting a temporal private/public key pair and a temporal certificate, wherein requesting includes submitting the authenticated credentials, receiving the authenticated credentials and generating a temporal private/public key pair and a temporal certificate associated with the authenticated credentials upon receipt of the authenticated credentials, and granting authenticated access to the computer network using the temporal certificate and the temporal private/public key pair.

Embodiments described herein include a method of authenticating users requesting access on a computer network, the method comprising initiating a smart card logon process, receiving a request for authenticated access to a computer network, deceiving a smart card reader driver into believing that a smart card is present, prompting for at least one user credential, receiving at least one credential in response to the prompt, validating the received at least one credential by providing authenticated credentials if the received at least one credential is valid, requesting a private/public key pair and a certificate based on the authenticated credentials, in response to the request for a private/public key pair and a certificate, presenting the authenticated credentials to obtain a temporal key pair and a temporal certificate, submitting the temporal key pair and the temporal certificate to the logon process as if it was read from a smart card, and granting authenticated access to the computer network using the temporal certificate and the authenticated credentials.

Embodiments described herein include a machine-readable medium comprising instructions stored on a computer memory, which when implemented by one or more processors perform the following operations: receiving a request for authenticated access to a computer network, prompting for at least one user credential, receiving at least one credential in response to the prompt, validating the received at least one credential by providing an authenticated credentials if the received at least one credential is valid, requesting a temporal private/public key pair and a temporal certificate, wherein requesting includes submitting the authenticated credentials, receiving the authenticated credentials and generating a temporal private/public key pair and a temporal certificate associated with the authenticated credentials upon receipt of the authenticated credential, and granting authenticated access to the computer network using the temporal certificate and the temporal private/public key pair.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. Therefore, it is intended that this invention be limited only by the claims and the equivalents thereof.

What is claimed is:

1. A user access control system for use in a computer systems having user authenticated accesses, the system comprising:
a workstation coupled to a computer network, the workstation operable to receive a request for an authenticated access to the computer network, and to prompt for and receive one or more credentials associated with the request;
a gating authentication server coupled to the computer network and operable to receive the one or more credentials provided through the workstation and to provide as a gating factor an authenticated credential as a gating factor in response to receiving and validating the one or more credentials; and
a public key infrastructure server coupled to the computer network and operable to generate private/public key pairs associated with the authenticated credential, wherein the private/public key pairs are generated after a request for access to the computer system has been received at the workstation and the gating authentication server has authenticated the one or more credentials provided through the workstation.

2. The user access control system of claim 1, including a certificate authority coupled to the computer network and operable to receive the authenticated credential and a request for a temporal certificate, and to generate a temporal certificate associated with the authenticated credential.

3. The user access control system of claim 1, including a virtual smart card server storage coupled to the computer network and operable to store a plurality of virtual smart cards and to receive allow access to a particular one of the virtual smart cards upon receiving the authenticated credential and a request for the particular virtual smart cards associate with the authenticated credential.

4. The user access control system of claim 1, wherein the workstation is coupled to the computer network through a local area network.

5. The user access control system of claim 1, wherein the workstation is coupled to the compute network through a wireless connection.

6. The user access control system of claim 1, wherein the workstation includes a smart card driver operable to generate a given public/private key pair, and to make a Certificate Signing Request (CSR) to a certificate authority in order to have the certificate authority issue a temporal certificate based on the given key pair.

7. The user access control system of claim 1, wherein the workstation includes a custom graphical identification and authentication module operable to prompt for and to collect the one or more credentials that are to be passed to the gating authentication server.

8. The user access control system of claim 1, wherein the workstation includes a virtual smart card driver coupled to a smart card login application and operable to receive a temporal certificate and to provide the temporal certificate to the smart card login application with one or more responses indicative of a smart card insertion and removal event without having a physical smart card insertion or removal event occur that is associated with the temporal certificate.

9. The user access control system of claim 1, wherein the workstation includes a smart card reader driver operable to generate smart card insertion and removal events that are then processed by a Winlogon process module included in the workstation.

10. A method of authenticating users requesting access on a computer network, the method comprising:
receiving a request for authenticated access to a computer network;
prompting for at least one user credential;
receiving at least one credential in response to the prompt;
validating the received at least one credential by providing an authenticated credentials if the received at least one credential is valid;
requesting a temporal private/public key pair and a temporal certificate, wherein requesting includes submitting the authenticated credentials;
receiving the authenticated credentials and generating a temporal private/public key pair and a temporal certificate associated with the authenticated credentials upon receipt of the authenticated credentials; and
granting authenticated access to the computer network using the temporal certificate and the temporal private/public key pair.

11. The method of claim 10, wherein generating includes submitting the generated temporal certificate to a smart card driver in order to complete a smart card logon to the computer network based on the authenticated credentials and the temporal certificate.

12. The method of claim 10, wherein receiving the at least on credential in response to the prompt includes receiving a user identification and a personal identification number.

13. The method of claim 10, wherein receiving at least one credential in response to the prompt includes receiving a one-time password.

14. The method of claim 10, wherein validating includes passing the received at least one credential to a gating authentication server.

15. The method of claim 10, wherein validating the received at least one credential by providing authenticated credentials includes receiving an authentication token in response to the request if the received at least one credential is valid.

16. The method of claim 10, wherein generating a temporal private/public key pair and a temporal certificate includes generating a public/private key pair, and providing the public/private key pair along with a certificate signing request to a certificate authority, the certificate authority operable to generate the temporal certificate based on the temporal private/public key pair.

17. The method of claim 10, wherein generating the temporal private/public key pair includes generating the private/public key pair at a smart card driver based on the authenticated credentials received from an authentication server.

18. A method of authenticating users requesting access on a computer network, the method comprising:
initiating a smart card logon process;
receiving a request for authenticated access to a computer network;
deceiving a smart card reader driver into believing that a smart card is present prompting for at least one user credential;
receiving at least one credential in response to the prompt;
validating the received at least one credential by providing authenticated credentials if the received at least one credential is valid;
requesting a private/public key pair and a certificate based on the authenticated credentials;
in response to the request for a private/public key pair and a certificate, presenting the authenticated credentials to obtain a temporal key pair and a temporal certificate;
submitting the temporal key pair and the temporal certificate to the logon process as if it was read from a smart card; and
granting authenticated access to the computer network using the temporal certificate and the authenticated credentials.

19. The method of claim 18, wherein obtaining the temporal key pair and the temporal certificate includes generating both the temporal key pair and the temporal certificate after receiving the at least one credential and after authenticating the at least one credential.

20. The method of claim 18, wherein obtaining the temporal key pair and the temporal certificate includes:
using the authenticated credentials to gain access to a previously stored virtual smart card associated with the authenticated credentials, and
reading a private/public key pair and a certificate from the previously stored virtual smart card associated with the authenticated credentials.

21. The method of claim 18, wherein obtaining the temporal key pair and the temporal certificate includes:
using the authenticated credentials to gain access to a previously stored virtual smart card associated with the authenticated credentials,
reading a private/public key pair from the previously stored virtual smart card associated with the authenticated credentials; and
and generating a temporal certificate using the previously generated private/public key pair by providing the previously generated private/public key pair to a certificate authority.

22. The method of claim 18, wherein responding to the request for a temporal certificate includes presenting the authenticated credentials in order to gain access to a certificate previously generated by a certificate authority and associated with the authenticated credentials.

23. The method of claim 18, wherein the stored virtual smart card is stored on a virtual smart card sever storage that is operable to store a plurality of virtual smart cards associated with a plurality of different authenticated credentials.

24. The method of claim 18, wherein the stored virtual smart card was generated in response to a previous request for access to the computer network.

25. A machine-readable medium comprising instructions stored on a computer memory, which when implemented by one or more processors perform the following operations:
receiving a request for authenticated access to a computer network;
prompting for at least one user credential;
receiving at least one credential in response to the prompt;
validating the received at least one credential by providing an authenticated credentials if the received at least one credential is valid;
requesting a temporal private/public key pair and a temporal certificate, wherein requesting includes submitting the authenticated credentials;
receiving the authenticated credentials and generating a temporal private/public key pair and a temporal certificate associated with the authenticated credentials upon receipt of the authenticated credentials; and
granting authenticated access to the computer network using the temporal certificate and the temporal private/public key pair.
